(19) United States
(12) Patent Application Publication
(10) Pub. No.: US 2010/0163439 A1
(43) Pub. Date: Jul. 1, 2010

(54) MULTI-CHAMBERED CONTAINER FOR STORING AND MIXING A FIRST AND SECOND SUBSTANCE INTO A COMPOSITION

(76) Inventor: Henry Alfonso Gutierrez Avendano, Duluth, GA (US)

Correspondence Address: Robert Z. Evora, 4741 Planters Walk, Douglasville, GA, 30135, US

(21) Appl. No.: 12/451,679

(22) PCT Filed: Jun. 6, 2008
(86) PCT No.: PCT/US2008/007155

§ 371 Date: Nov. 24, 2009

Related U.S. Application Data
(60) Provisional application No. 60/933,734, filed on Jun. 8, 2007.

(51) Int. Cl. B65D 25/08; B65D 81/32; A61J 9/00; B01F 11/00

(52) U.S. Cl. 206/219; 366/130; 220/521

(57) ABSTRACT

A multi-chambered container for storing and/or mixing a first substance and a second substance into a composition. The multi-chambered container includes upper chamber having a first end and a second end. A collar is fastened to a nipple to the first end of the upper chamber. A lower chamber is fastened to the second end of the upper chamber. A seal is disposed between the second end of the upper chamber and the lower chamber. A sheet is disposed in an aperture between the seal and the lower chamber. The sheet separates the first substance in the upper chamber from combining with the second substance in the lower chamber. In use, the sheet is removed from the upper chamber through the aperture from a closed separating position, to an open mixing position in which the first substance and second substance are allowed to mix into the composition.

### CROSS REFERENCE TO RELATED APPLICATION

This application is a Non-Provisional which claims the benefit of the filing date of U.S. Provisional Application Ser. No. 60/763,433, entitled “Chambered Bottle for Storing, Mixing and Dispensing a Beverage Composed of a Predetermined Dosage of a First and Second Substance” filed Jun. 8, 2007, the entirety of which is incorporated herein.

### BACKGROUND OF THE INVENTION

1. Field of the Invention

The invention relates to a compact, portable storing, mixing and/or dispensing unit. In particular, this invention is directed to storing and mixing a predetermined quantity of a composition of a first and a second substance.

2. Description of the Related Art

Traditionally, when an adult travels with an infant from their home, it is essential to pack and carry numerous bulky and cumbersome baby products. In particular, it is necessary to pack various items to anticipate the infant's meal, such as, sterile baby bottles, one or more sterile water-filled bottles and various containers of a baby formula powder, a measurement scooper, a bib and baby wipes. The burden of having to carry all of these items to feed the infant when they are hungry (which included mixing a measured amount of water with a predetermined amount of baby formula powder, using a scoop to put the powder inside the nursing bottle when the user needed to feed the infant), makes traveling anywhere outside of the home discouragingly complicated and an unsatisfying experience.

When baby formula is mixed with water, the recommended time for consumption is within about an hour. Thereafter, it was recommended that the remainder of the formula beverage be discarded to prevent the introduction of bacteria and/or other harmful germs to an infant. (See http://www.ehow.com/how_{—}2514_prepare-ready-mix.html). Consequently, any unfinished formula remaining in the bottle, shortly after the infants feeding, is discarded (See http://www.childrensmercy.org/CareCard/CardNiew.asp?lang=e&id=CMH-04-258). In an attempt to extend the use of formula by keeping the ingredients separated until use, various bottle designs have been proposed which have still unsuccessfully provided a simple bottle design that stores, mixes and easily dispenses the beverage.

For example, U.S. Pat. No. 6,045,254 to Inbar et al. (1997), U.S. Pat. No. 6,575,208 to Igal et al. (2001), and U.S Patent Application 20010039977 to Igal et al. (2001) disclose a complex bottle having two chambers, one for water and another for powder. A rotating displaceable partition between the chambers allows the components to mix. The chambers are integral parts of the bottle, requiring the caregiver to purchase the entire bottle as a unit. Unfortunately, the bottle is expensive and has numerous unnecessary moving parts and is designed for pre-packaged single use. Likewise, this design is not interchangeable with other bottle already in one's possession. Even if it were re-useable, the complicated bottle assembly, and numerous it parts, makes washing more difficult and timely since extra care is necessary to ensure that all surfaces and crevices are thoroughly cleansed prior to reuse.

U.S. Patent Application No. 20050056608 illustrates a feeding bottle including an insert into which an amount of powder is stored within. The insert releases the powder into the water when a force external to the bottle is applied over the nipple by a user's hand. The disadvantage of this design is that the nipple is exposed to the contamination of the user's hand. Likewise, the process required to place the powder into the insert is difficult because the insert opening is small.

For at least these reasons, the prior art devices solutions suffer to solve the problem of efficiently storing, mixing and/or dispensing of a formula beverage.

### SUMMARY OF THE INVENTION

An object of the present invention is to provide a compact and portable multi-chambered container for storing and mixing a composition. The container includes chambers for storing a first substance (or composition) and a second substance (or composition).

The multi-chambered container includes an upper chamber and a lower chamber. The lower chamber is fastened to the upper chamber and a seal is disposed there-between. A sheet is disposed in an aperture located between the seal and the lower chamber. The sheet separates a first substance in the upper chamber from combining with a second substance in the lower chamber. In use, the sheet is removed from the upper chamber through the aperture from a closed separating position, to an open mixing position in which the first substance and second substance are allowed to mix into the composition.

The upper chamber of the multi-chambered container may be attached to a nipple with a collar and constructed for use as a nursing bottle.

According to another aspect of this invention, a chambered cap for use with a container includes a closed end and an open end having a fastening mechanism adapted to secure the cap to the container. A compartment is defined within the cap and is adapted to store a first substance. A seal is disposed between the compartment and the open end of the cap. A sheet is disposed in an aperture. In a closed position, the sheet prevents the first substance in the cap from being released. When the sheet is removed from the cap, the first substance may be released from the compartment.

This invention solves the longstanding need for providing a simple to use, quick and portable chambered sterile bottle. These and other objects, features, and/or advantages may accrue from various aspects of embodiments of the present invention, as described in more detail below.

### BRIEF DESCRIPTION OF THE DRAWINGS

Various exemplary embodiments of this invention will be described in detail, wherein like reference numerals refer to identical or similar components or steps, with reference to the following figures. Likewise, some of the figures herein depict minimal line-work for ease of understanding.

Various exemplary embodiments of this invention will be described in detail, wherein like reference numerals refer to identical or similar components or steps, with reference to the following figures, wherein:

FIG. 1 illustrates an exemplary side exploded perspective view of a multi-chamber container in accordance with this invention.

FIG. 2 illustrates another exemplary exploded perspective view of a multi-chamber container in accordance with this invention.

FIG. 3 is a section view of an upper chamber according to this invention.

FIG. 4 is a section view of a seal in accordance with this invention.

FIG. 5 is a section side view of a sheet in accordance with this invention.

FIG. 6 is a view of another sheet in accordance with this invention.

FIG. 7 is a section view of a lower chamber in accordance with this invention.

FIG. 8 is a section view of the multi-chamber container assembled in accordance with this invention.

FIG. 9 is a section view of the multi-chamber container showing the separation by the sheet of a first substance and a second substance in accordance with this invention.

FIG. 10 is a section view of the multi-chamber container showing the removal of the sheet and agitation of the container causing the mixture of the first and second substances to form a sealed composition in accordance with this invention.

FIG. 11 illustrates another exemplary embodiment for an end of the upper chamber in which a seal is integrally incorporated at a peripheral end of the upper chamber in accordance with this invention.

FIGS. 12, 13 and 17 illustrates another exemplary embodiment for providing a seal in accordance with this invention.

FIGS. 14 and 15 illustrate another exemplary embodiment for providing a seal in accordance with this invention.

FIG. 16 illustrates another exemplary embodiment for providing a seal integrated as part of the upper chamber in accordance with this invention.

FIGS. 18 and 19 illustrate yet another exemplary embodiment for providing a seal in accordance with this invention.

FIGS. 20 and 21 depict another exemplary arrangement for use of the seal in accordance with this invention.

FIGS. 22 and 23 depict yet an exemplary embodiment in which various seals are disposed between a perforated upper chamber wall and a perforated lower chamber wall in accordance with this invention.

FIG. 24 depicts an exemplary chambered cap according to this invention.

FIG. 25 depicts an exemplary multi-chamber device according to this invention.

FIG. 26 depicts an exemplary embodiment for the chambered cap adapted to be secured to a neck of a bottle according to this invention.

### DETAILED DESCRIPTION OF EXEMPLARY EMBODIMENTS

Particular embodiments of the present invention will now be described in greater detail with reference to the figures.

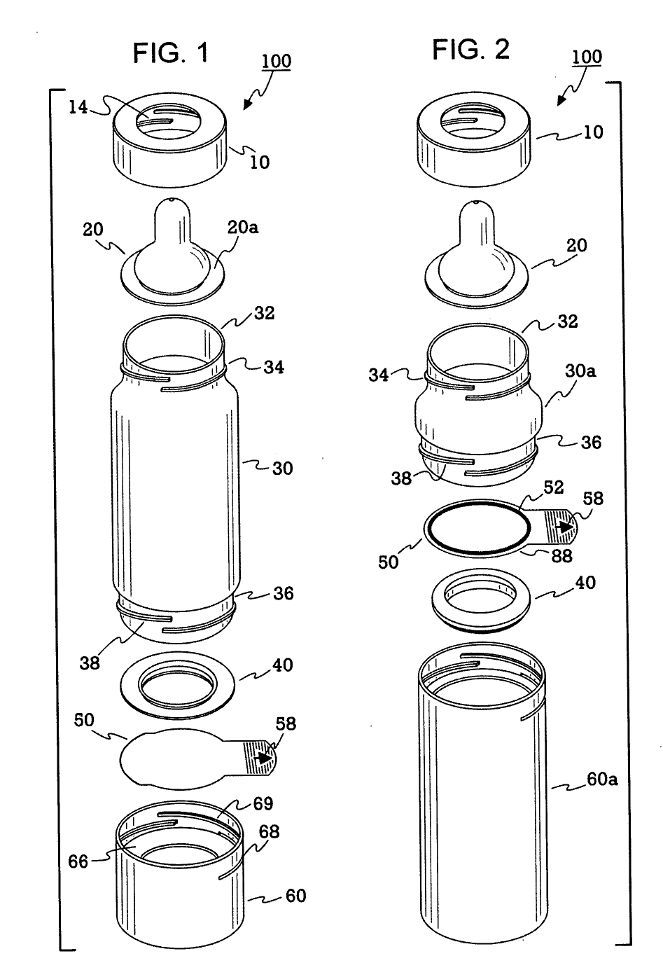

FIG. 1 illustrates a compact modular and portable multi-chamber container including various sub-chambers. The container may be adapted for a variety of different uses, such as for use to mix a variety of different ingredients.

For exemplary purposes, the multi-chamber container is configured a nursing bottle (hereafter referred to as a multi-chamber bottle 100). The multi-chamber bottle 100 is constructed to separate, store, mix and dispense a baby formula beverage. In more detail, the multi-chamber bottle 100 of FIG. 1 illustrates at an upper end 32 of an upper chamber (hereafter referred to as an upper bottle 30), a collar 10 adapted to secure and compress a nipple 20 to the upper end 32 of the upper bottle 30. At a lower end 36 of the upper bottle 30, a lower chamber (hereafter referred to as a lower container 60) is provided and adapted to be secured to the lower end 36 of the upper bottle 30. A seal 40 and a sheet 50 are disposed between the lower container 60 and the upper bottle 30. The sheet 50 is adapted to separate a first substance disposed within the lower container 60 from a second substance disposed within the upper bottle 30 and the seal 40 is provided to prevent leakage of the two substances at the junction where the lower end 36 of the upper bottle 30 and the open end 62 of the lower container 60 are joined.

According to this exemplary embodiment, the upper bottle 30 may hold a variety of different substances, including but not limited to: a powder, a liquid, such as water. Likewise, the lower container 60 may also be filled with any one of a variety of different substances intended to be mixed with the substance in the bottle to make a beverage, including but not limited to: a powdered formula (e.g., an infant formula), and/or any other type of liquid or powdered beverage drink additive (such as tea, punch, sports hydration drink, and the like). Likewise, the multi-chambered device may be used for medicinal, chemical and/or any other purpose as will be described later.

Although threaded fasteners 14, 34, 38 and 69 (also, 84 and 69a discussed later) are shown as the preferred fastening mechanisms between the upper end 32 of the upper bottle 30 and the collar 10, the second lower end 36 of the upper bottle 30 and the lower container 60 (and the lower open end 82 of the chambered cap 200 and the bottles 30b and 30c, as shown in FIGS. 24-26), it is to be understood that various types of fastening mechanisms may be employed in accordance with this invention, such as for example, clip-locks, snap-locks, glue, detents and/or any other type of fastening means now known or later discovered.

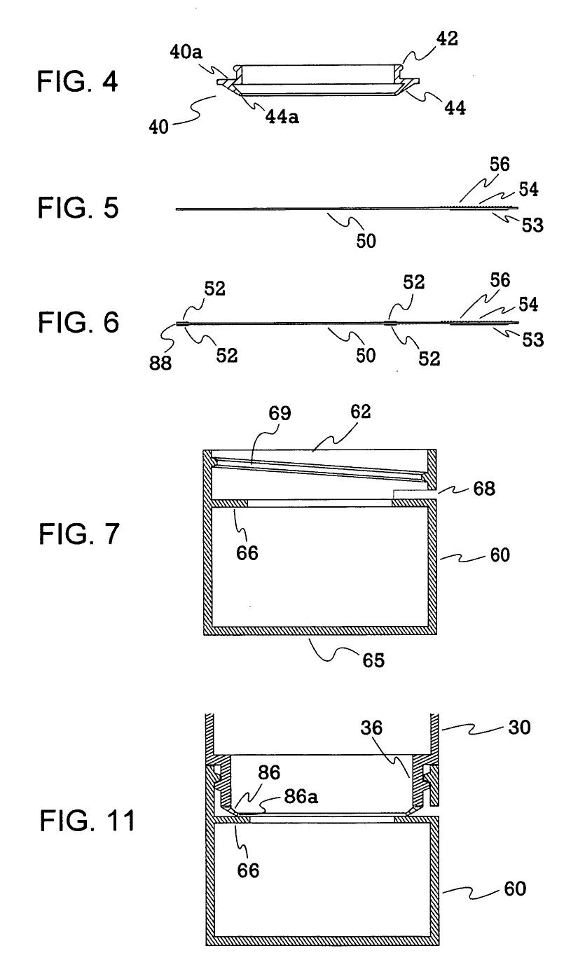

Various materials may be used as the composition for the various component parts of the multi-chamber bottle 100. For example, the collar 10, bottles 30, 30a, 30b, 30c, containers 60, 60a, and housing 80 and any part thereof, may be constructed from a polymer, a metal and/or any other composition having similar rigid properties. The sheet 50 may be composed of rubber, polymer, metallic material and/or any other type of material also capable of (but not essential) having closing properties for dividing the substances. Likewise, the seal 40, as shown in FIG. 4, may be constructed using different shapes, sizes and/or configurations, as for example shown in the embodiments for seals: 46, 86, 132, 134, 136, 138 and 186; and may be composed of any type of flexible material such as rubber, a polymer and/or similar material having sealing properties capable of preventing leakage between the bottles 30, 30a, 30b, 30c, the containers 60, 60a, and housing 80; that are now known or later discovered in accordance with this invention.

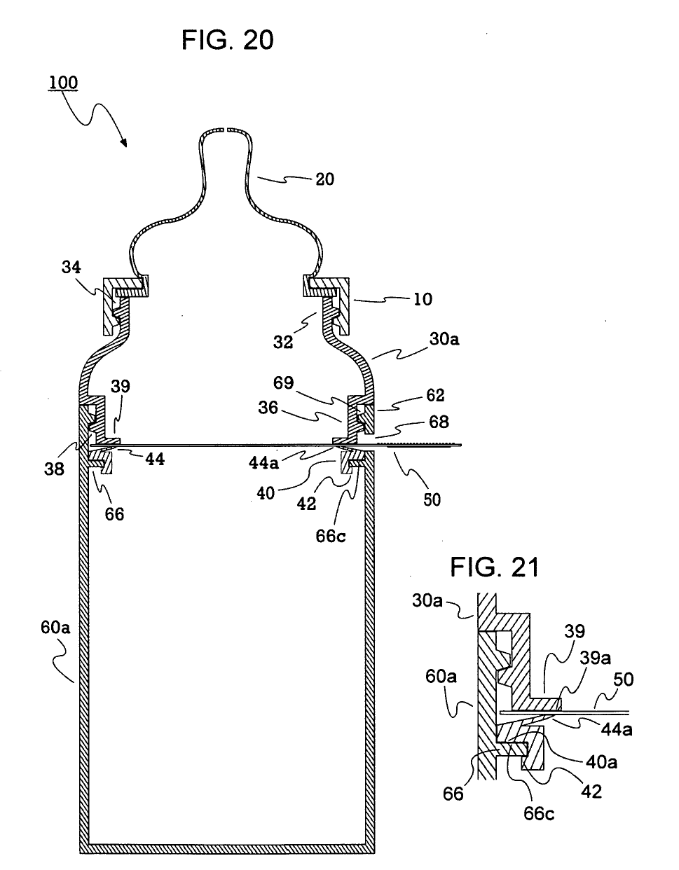

FIG. 2 illustrates an exploded perspective view of another exemplary embodiment for the multi-chamber bottle 100 that is similar in operation to the multi-chamber bottle 100 shown in FIG. 1. FIG. 2 demonstrates the flexibility in the modular construction of the various components of this invention. In particular, the shape of the upper chamber (hereafter the second bottle 30a) and the lower chamber (hereafter the second container 60a) in FIGS. 2 and 20 are shown as being different in size from the upper bottle 30 and the lower container 60 shown in FIG. 1 and FIG. 8. That is, the second bottle 30a shown in FIG. 2 is smaller in axial length than the upper bottle 30 in FIG. 1. Likewise, the second container 60a shown in FIGS. 2 and 20 is longer in axial length than the lower container 60 shown in FIG. 1. Throughout this description, it is to be understood that elements 30 and 60 may be interchangeable with 30a and 60a in function and construction.

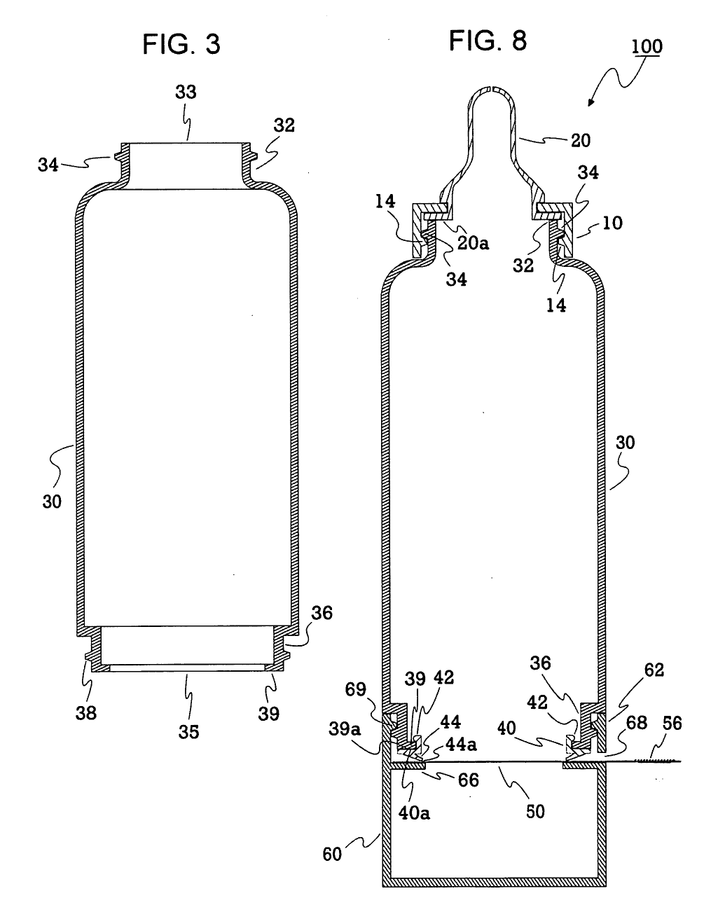

FIG. 3 depicts an exemplary sectional view of the upper bottle 30 (or upper chamber) shown in hollow construction. At the upper end 32, the upper bottle 30 includes an opening 33 having outer threads 34 adapted to be received by a mating pair of interior threads 14 disposed on an interior rim of the collar 10 as shown in FIGS. 1 and 8. As the collar 10 is rotated about the upper end 32 of the upper bottle 30, interior threads 14 of the collar 10 are tightly engaged with outer threads 34 of the upper bottle 30 thereby sealing and fastening by compression a flange portion 20a of the nipple 20 between collar 10 and upper bottle 30 adjacent to the upper end 32 thereof. It is understood that the upper bottle 30 may be assembled in a variety of ways not limited to this embodiment.

Likewise, at the lower end 36, the upper bottle 30 includes another opening 35 also having outer threads 38 adapted to be received by a mating pair of interior threads 69 disposed on an interior rim of the lower container 60 as shown in FIGS. 1, 3 and 8. As the lower container 60 is rotated on to the lower end 36 of the upper bottle 30, the interior threads 69 of the lower container 60 are tightly engaged with the outer threads 38 so that a bottom sealing flange 44 of the seal 40 and the sheet 50 are fastened between the lower container 60 and the upper bottle 30. As shown in FIGS. 3, 4 and 8, the upper bottle 30 also illustrates an retaining rib 39 adapted to abut adjacent to a seat lip 40a portion of the seal 40.

FIG. 4 illustrates an exemplary hollow cross-section configuration for the seal 40. The seal 40 is preferably made of a ring of a flexible material. As shown in FIGS. 3, 4 and 8, the seal 40 includes an upper retaining rib 42 which in position is disposed adjacent to an end of the retaining rib 39 at the lower end 36 of the upper bottle 30. A lower surface 39a of the retaining rib 39 rests against the seat lip 40a portion of the seal 40. Together, the upper retaining rib 42 and the seat lip 40a portion of the seal 40 are contoured to receive the retaining rib 39 of the upper bottle 30.

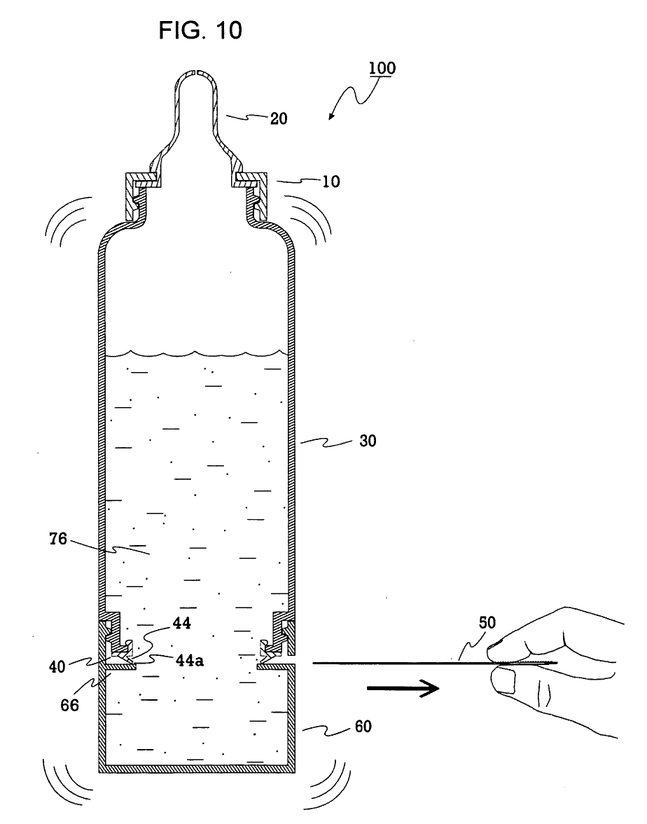

The seal 40 further includes a sealing flange 44. The sealing flange 44 is provided to seal the sheet 50 in position between the upper bottle 30 and the container 60. Likewise, the material properties of the sealing flange 44 also assist in flexibly sealing the region between the upper bottle 30 and the lower container 60 when the sheet 50 has been removed, as shown in FIG. 10. That is, the lowermost peripheral edge 44a on the sealing flange 44 slightly opens outwardly downward against the inward rib 66 of the lower container 60 to fill any gap formed by the removal of the sheet 50 thereby fluidly sealing the connection by preventing any of the substance within the multi-chamber bottle 100 to leak out from between the upper bottle 30 and the container 60.

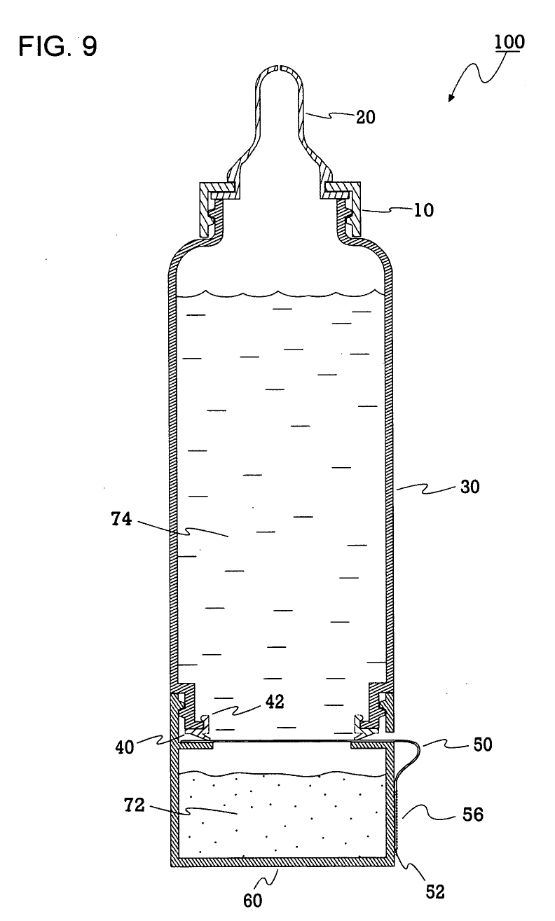

Although substantially shaped as a curved ring, the seal 40 may be shaped in any configuration to conform to the shape of the connection between the upper bottle 30 and the container 60. The same applies for the various other seals (46, 86, 132, 134, 136, 138 and 186) located between bottles (30a, 30b, 30c) and containers (60a) or housing (80). The object of the seal 40 is to provide a sealing mechanism between the upper bottle 30, the sheet 50 and the container 60. Various other exemplary constructions will be shown and describe later in more detail. It is to be understood that the shape, orientation, location and construction of the seal 40 may be different and/or may be modified based on the construction of the junction(s) between a bottle and a container of different containers to be employed in accordance with this invention. For example, in FIGS. 8 and 9, the seal 40 is shown fastened to the retaining rib 39 on the upper bottle 30, and the sealing flange 44 is biased downwardly outward against an inward ridge 66 on the container 60. On the contrary, in FIG. 20, the seal 40 is arranged inverted and fastened to the inward ridge 66 on the second container 60a, and the sealing flange 44 is biased upwardly outward against the retaining rib 39 on the upper bottle 30. As shown, the inversion of the seal 40 causes the retaining rib 39 and the inward ridge 66 to reverse functional roles.

FIG. 5 depicts an exemplary illustration of the sheet 50 that separates a first substance 74 from a second substance 72 in the multi-chamber bottle 100 as shown in FIG. 9. The sheet 50 may include a raised gripping surface 54 that is textured so that a user can easily grip and pull the accessible tab end 56 of the sheet 50. The sheet 50 may also include an adhesive portion 53 disposed thereon so that when the sheet 50 is not in use, the tab end 56 may be tucked away against the multi-chamber bottle 100. Tucking and adhering the tab end 56 of the sheet 50 against the upper bottle 30 (as shown in FIG. 9) will prevent the sheet 50 from being accidentally pulled and inadvertently allowing the first 74 and second 72 substances to mix. Likewise, the first 74 and second 72 substances, may be any number of a variety of different substances, combination of substances, etc; which may include but are not limited to, powdered, granulated, fluid, and/or other form of a food, chemical, drug, etc. to be employed in accordance with this invention

Alternatively, and as shown in FIGS. 1 and 2, the sheet 50 may include indicia, such as an operation directional arrow “→” 58 demonstrating to the user the direction in which to pull the sheet 50 from within the multi-chamber bottle 100 to allow the first substance 74 and the second substances 72 to mix for use as a beverage or the like. Various other instructions, labels, indicia and/or decorative printing may be provided on the multi-chamber bottle 100 in accordance with this invention. It is understood that any portion of the multi-chamber bottle 100 may be decoratively designed for various reasons, such as to provide instruction, labeling and/or an aesthetic appearance. For example, the sheet 50 may have decorative indicia and/or drawings, making the multi-chamber bottle 100 visually attractive and/or entertaining to an infant.

FIG. 7 shows an exemplary cross-section view of the container 60. As shown, the lower container 60 includes an open end 62 and a closed end 65. The open end 62 of the lower container 60 includes interior threads 69 adapted to be received by the outer threads 38 of the upper bottle 30.

An aperture 68 is also disposed in the container 60. The aperture 68 is adapted to receive the sheet 50. As shown, the aperture may be constructed as a thin slot in the side of the lower container 60 that is just large enough to allow ingress and egress of the sheet 50 at a location adjacent to where the seal 40, the upper bottle 30 and the lower container 60 are secured to each other.

In an alternative embodiment, where the sheet 50 is constructed to at least partially remain in the multi-chamber bottle 100, chambered cap 200, and/or multi-chambered container 300, the sheet 50 may be configured to rest in a first closed position in which the first 74 and second 72 substances are kept separated. In a second open position, the sheet 50 is partially slid out of the multi-chamber bottle 100, chambered cap 200, and/or multi-chambered container 300 defining a passage to allow the first 74 and second 72 substances to mix together. In accordance with this invention, the sheet 50 may be designed more durably for repetitive numerous use. Likewise, the aperture 68 will be optimally designed to allow the sheet 50 to slide in and out of the first and second position.

FIG. 8 is a simple exemplary cross-section side view of an assembled illustration of the multi-chamber bottle 100. In construction, the multi-chamber bottle 100 shows the nipple 20 secured to the upper end 32 of upper bottle 30. That is, a flange portion 20a of the nipple 20 is securely urged against the collar 10 by the upper edge of the upper end 32 of the upper bottle 30 by a compression force generated by the threaded interaction of the interior threads 14 on the collar 10 cinching against the outer threads 34 on the upper bottle 30. In a position, the flange portion 20a of the nipple 20 fluidly seals the collar 10 to the upper bottle 30.

Furthermore, the seal 40 is disposed between the lower end 36 of the upper bottle 30 and the container 60. Likewise, the seal 40 is adapted to seal and leakage of fluid as a result of a compression force generated when the lower container 60 is screwed onto the lower end 36 of the upper bottle 30. That is, as the lower container 60 is screwed onto the upper bottle 30, the interior threads 69 on the lower container 60 are cinched against the outer threads 38 on the upper bottle 30, thereby generating a compression force between the lower container 60 and the upper bottle 30. The compression force generated by the threads 69, 38 is translated to the lowermost peripheral edge 44a of the seal 40 urging against the sheet 50 to secure the sheet 50 under compression against inward rib 66 of the container 60. The seal 40 and the sheet 50 form a liquid tight seal at the connection joint between the upper bottle 30 and the container 60.

In operation, and as shown in FIG. 10, when the sheet 50 is removed from between the lowermost peripheral edge 44a of the seal 40 and the inward rib 66 of the container 60, the lowermost peripheral edge 44a opens outward and downward as it is further compressed onto the inward rib 66 thereby filling any void from the removal of the sheet 50. As in exemplary embodiments shown in FIGS. 9 and 10, a liquid proof seal is again formed between the upper bottle 30 and the lower container 60 absent the sheet 50 in place, and the first 74 and second 72 substances are permitted to mix into a composition 76. The user may then speed up the mixing process by agitating/shaking, the multi-chamber bottle 100 until the first 74 and second 72 substances are uniformly mixed into the composition 76 or as shown in FIG. 10. The composition 76 may then be conventionally fed through the nipple 20 and/or other delivery outlet to the infant, child, adult, and/or any other person or animal in accordance with this invention.

It is also to be understood that, instead of removing the sheet 50 from within the multi-chamber bottle 100, chambered cap 200, multi-chambered container 300, through aperture 68, allowing to mix the first 74 and second 72 substances may be performed by breaking through the plane and/or removing the closing function of the sheet 50 that separates the first 74 and second 72 substances. Breaking, separating and/or removing the closing function the sheet 50 may be performed in a various ways, including but not limited to, plunging and/or piercing with an object, peeling, tearing.

It is to be understood that the multi-chamber bottle 100, chambered cap 200, multi-chambered container 300, and/or parts thereof, may be disposably constructed. For example, the entire multi-chamber bottle 100 or portions thereof may be inexpensively manufactured and designed to be discarded after each use. Various advantages are gained making the bottle disposable. For example, a parent may pack enough disposable bottles for the duration of a daily outing. The multi-chamber bottle 100 may be discarded after each use thereby reducing the number of baby supplies collected and accounted for throughout the day. Further, eliminating the need to clean and sterilize the bottle for the next use. In our rapidly changing fast-paced mobile environment, it is clear that there is a substantial need for these self-contained time saving bottles.

Likewise, the multi-chamber bottle 100 and/or portions thereof may be durably constructed for repetitive use as with various conventional nursing bottles. After use, the bottle may be conveniently disassembled and each of the components may be washed and sterilized as is conventionally done with reusable nursing bottles. Unlike conventional nursing bottles, the modular open construction of this multi-chamber bottle 100 makes the washing and sterilizing process quicker, simple and less complicated. As briefly mentioned above, the sheet 50 may be constructed in a disposable manner so that it is replaced after each use and/or may be constructed for numerous uses.

FIG. 11 illustrates another exemplary embodiment in which a seal is integrally incorporated as part of the upper bottle 30. According to this embodiment, the retaining rib 39 is removed and a seal 86 is integrated at a lower end 36 of the upper bottle 30. The seal 86 has a tapered flange 86a portion which contacts an adjacent component (herein shown as inward ridge 66) and provides sealing from leakage of any substance contained within the upper bottle 30. The seals 40, 46, 86, 132, 134, 136, 138, 186 may be integrally incorporated onto the multi-chamber bottle 100 as (but not limited to) part of the upper bottle 30 (shown in FIG. 11). It is to be understood that the seals 40, 46, 86, 132, 134, 136, 138, 186 may be fused to any part of the multi-chamber bottle 100 and/or multi-chambered container 300 in accordance with this invention.

Instead of fusing the seal 86 to the bottle, it is to be understood that the seal 86 may have been secured using various physical processes for mixing, fusing and adhering (e.g., mixing both, gluing, welding, thermally bonding and/or any other method now known or later discovered process for adhering two components to each other) to the lower end 36 of the upper bottle 30. Likewise, the seal 86 may be secured to any portion of the bottle multi-chamber bottle 100, chambered cap 200, multi-chambered container 300 in any of the above described methods. For example, in FIG. 20 the seal 40 may be adhered to the second container 60a. As mentioned with respect to seal 40, seals 46, 86, 132, 134, 136, 138, 186 may be constructed in a variety of different sizes and shapes.

In accordance with this invention, the multi-chamber bottle 100 and/or any part thereof may be made from material containing resilient properties so that no seal may be needed. By way of example, in FIGS. 24 and 25, the seal 186 may be constructed from the same material as the housing 80. The material may provide sealing properties without an additional seal being used there-between the edge of the seal 186 and an adjacent component (such as the sheet 50 or the peripheral end of the lower bottle 30b).

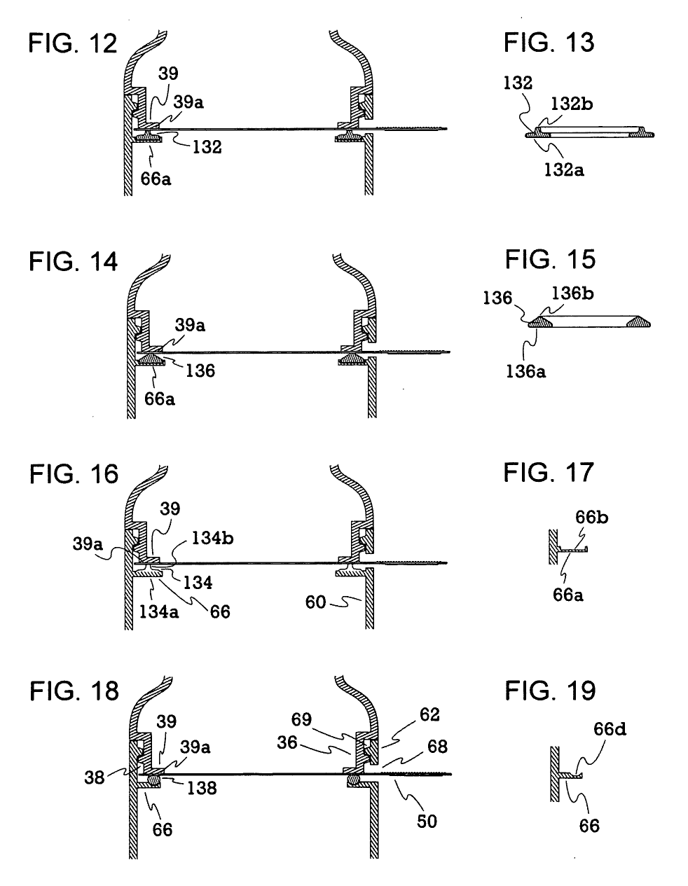

FIGS. 8 and 12-26 illustrate various simple, exemplary embodiments for integrating a seal in accordance with this invention. In particular, FIG. 12 illustrates a seal 132 including a nipple-like cross-sectional shape, and FIG. 13 illustrates the cross-section of the seal 132 includes a flat base 132a and a pinched protruding tip 132b.

FIGS. 12 and 17 show that the seal 132 may be recessed within a recessed inward ridge 66a constructed with a recess 66b. In position, a recess 66b is adapted to receive and captivate the flat base 132a of the seal 132 in position. In operation, the pinched protruding tip 132b extends outward and away from the flat base 132a and abuts up against a lower surface of the retaining ridge 39.

FIGS. 14 and 15 include a similar construction for a seal 136. However, in FIGS. 14 and 15, another exemplary seal 136 is constructed with a frustoconical shape. That is, as shown in FIGS. 14 and 15, the seal 136 includes a flat base 136a that tapers into a protruding frustoconical tip 136b. As shown and described above in FIGS. 15 and 17, the seal 136 may be positioned in the recess 66b within a recessed inward ridge 66a adapted to receive and captivate the flat base 136a of the frustoconical seal 136. In operation, the frustoconical protruding tip 136b extends outward away from the flat base 136a and abuts up against the lower surface 39a of the retaining ridge 39.

FIG. 16 depicts yet another exemplary embodiment for an integrated seal 134 fused into a portion of the bottle 60. The integrated seal 134 shown in FIG. 16 is fused onto the inward ridge 66 so that the composition of the integrated seal 134 transitions from a rigid material composition 134a to a resilient material composition at the upper end of the integrated seal 134. In particular, integrated seal 134 is fused onto the inward ridge 66 so that the integrated seal 134 becomes an integral part of the inward ridge 66. The integrated seal 134 may be fused to the inward ridge 66 at a base portion of the inward ridge 66.

Likewise, the integrated seal may take a variety of different configurations including the construction shown in which the base of the rigid material composition 134a of the integrated seal 134 tapers into a pinched protruding tip 134b configuration. In operation, the pinched protruding tip 134b extends outward from the base of the rigid material composition 134a and is fused on to the inward ridge 66. The pinched protruding tip 134b abuts up against the lower surface 39a of the retaining rib 39 and provides a seal preventing leakage of the substances and/or composition contained within the multi-chamber bottle 100.

FIGS. 18 and 19 illustrate another exemplary embodiment for a seal and an inward ridge 66 in accordance with this invention. In particular, FIGS. 18 and 19 show the cross-section of a seal 138 and a groove 66d disposed in the inward ridge 66. As shown, the seal 138 may be recessed and secured within groove 66d disposed within the inward ridge 66. The groove 66d is contoured to receive and captivate a portion of the seal 138. In operation, the seal 138 secures the sheet 50 in place by compressing the sheet 50 against the lower surface 39a of the retaining ridge 39.

FIG. 20 depicts another exemplary arrangement for providing the seal 40 in accordance with this invention. In particular, FIG. 20 illustrates the versatility of providing a seal arrangement in accordance with this invention. In contrast to the placement of the seal 40 as shown in FIGS. 8-10 where the seal 40 is secured to the retaining rib 39 of the upper bottle 30, the placement of the seal 40 shown in FIGS. 20 and 21 demonstrates the seal 40 being secured to the inward ridge 66 of the second container 60a in an inverted position from the seal 40 depicted in FIGS. 8-10. As shown in FIGS. 20 and 21, the seal 40 includes a retaining rib 42 which is wrapped around a peripheral edge of the inward ridge 66. An upper flat portion 66c of the inward ridge 66 rests against the seat lip 40a portion of the seal 40. Together, the retaining rib 42 and the seat lip 40a portion of the seal 40 form a “C” hook-like contour into which the inward ridge 66 of the second container 60a is received and secured.

As shown, the peripheral edge 44a of the sealing flange 44 is biased upward and is urged against the lower surface 39a of the retaining rib 39. The sealing flange 44 is provided to seal the interface between the second bottle 30a and the second container 60a. As shown in FIGS. 20 and 21, when the sheet 50 is in position, the peripheral edge 44a of the sealing flange 44 is biased upward and is urged against the sheet 50 thereby sealing the contents within the second container 60a from escaping between the seal 40 and the sheet 50. In an alternative embodiment (not shown), the retaining rib 39 may be removed and a lower edge surface (analogous to the upper edge 37a as shown in FIG. 25) of the lower end 36 of the second bottle 30a may be in contact with the seal 40.

When the sheet 50 is removed, the peripheral edge 44a of the sealing flange 44 slightly biases open outward and up against the lower surface 39a of the retaining rib 39 in order to fill any gap formed by the removal of the sheet 50 sealing the connection between the second bottle 30a and the second container 60a thereby preventing any of the substance contained within the multi-chamber bottle 100 from leaking out through the seal 40.

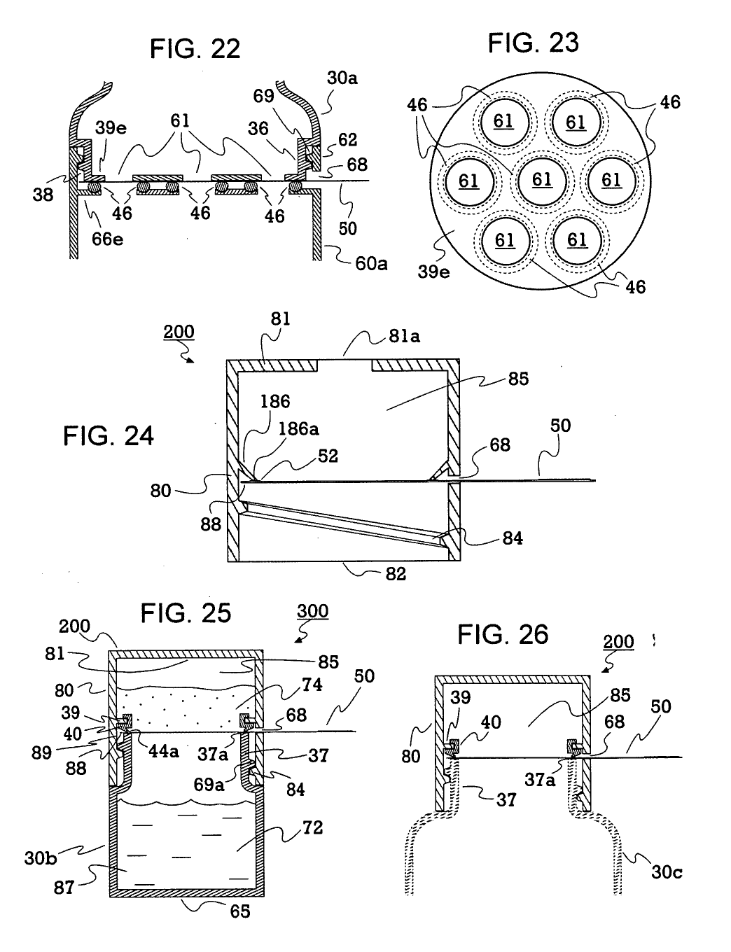

FIG. 22 depicts yet another exemplary embodiment for the multi-chamber bottle 100 in which a perforated divider portion may be configured to include various seals 46 disposed at an interface between the second container 60a and the second bottle 30a in accordance with this invention. In particular, FIG. 22 illustrates an axial cross-section view, and FIG. 23 depicts a plan cross-section view of various seals 46 and associated perforations 61 disposed therein.

As shown in FIG. 22, the seal 46 may be located between a perforated bottle wall 39e and a perforated container wall 66e. The various seals 46 provide a fluid seal between the perforated bottle wall 39e and the perforated container wall 60e.

Likewise, the perforated container wall 66e may includes grooves 66d (as described in FIG. 19) recessed within perforated container wall 66e which are contoured to secure and receive a portion of the various seals 46 while in position during operation. In operation, various seals 46 operate together to captivate sheet 50 by compressing the sheet 50 against the perforated bottle wall 39e. In use, the sheet 50 is removed from between the various seals 46 and the perforated bottle wall 39e. The first substance 74 and the second substance 72, are allowed to flow through the perforations 61 and are then permitted to mix into a composition 76 in the multi-chamber bottle 100 (as shown in FIGS. 9 and 10). It is to be noted that the perforations 61 and seals 46 may be configured in a variety of associated shapes, sizes and quantities. Alternatively, a single seal may be constructed to include various perforated holes therein, aligned with the perforations 61 to perform the same sealing function.

FIGS. 24-26 illustrate exemplary embodiments for a chambered cap 200 and a multi-chambered container 300 in accordance with this invention. In FIG. 25, the fluid seal is provided between the housing 80 and the lower chamber (hereafter, lower bottle 30b). The chambered cap 200 and the multi-chambered container 300 are constructed similar to the multi-chamber bottle 100 above, except the upper bottle 30 (as shown in FIGS. 1) switches to become the lower bottle 30b (as shown in FIG. 25), and the upper end 32 and lower end 36 of the upper bottle 30 switches to become the closed end 65 and the neck opening 37 respectively. As shown, the housing 80 includes the aperture 68 adapted to receive the sheet 50. The chambered cap 200 and multi-chambered container 300 may be constructed in different sizes, shapes and/or configurations in accordance with this invention.

It is to be understood that the various features and functionality described with respect to the multi-chamber bottle 100 describe above is intended to be similar and interchangeable with the chambered cap 200 and multi-chambered container 300 which will be described in more detail below.

FIG. 24 shows the chambered cap 200 including a housing 80 having an upper closed end 81 and a lower open end 82. A compartment 85 is disposed within the housing 80 and is adapted to store a first substance 74 (as shown in FIG. 25). As shown, the housing 80 may be constructed to include an opening 81a and/or portion through which could be accessed the composition 76 (as shown in FIG. 10). Likewise, the opening 81a may be constructed as: a plug, a door, a penetrable layer, etc.; which may be inserted by a penetrable object, removed and/or any other closing mechanism for closing and/or allowing access to the composition 76.

As shown in FIGS. 24 and 25, a fastening mechanism 84 is provided inside of, and adjacent to, the lower open end 82 of the housing 80. The fastening mechanism 84 is adapted to mate with, and be secured to, another mating fastening mechanism 69a disposed at one end of the lower bottle 30b.

In FIG. 24, another exemplary seal 186 is provided between the compartment 85 and the lower open end 82 of the housing 80. In the alternative to FIG. 11, herein, the chambered cap 200 and the seal 186 may be designed as one integral part, where the seal 186 is not fused to the housing 80. Although an integrated seal 186 is shown in FIG. 24, it is to be understood that the seal disposed within the chambered cap 200 can take various exemplary designs which are described herein with respect to the multi-chamber bottle 100 described above and those commonly known in the industry or later discovered.

An aperture 68 is disposed on the housing 80. The sheet 50 is disposed through the aperture 68 and located between the integrated seal 186 and the lower open end 82 (see FIG. 24) of the housing 80. As shown in FIG. 25, the sheet 50 is adapted to separate the first substance 74 in the chambered cap 200 from being released into (or permitted contact with) the lower bottle 30b and mixing with the second substance 72 in the lower bottle 30b.

FIG. 24 depicts the chambered cap 200. Since it is possible to package and/or distribute the chambered cap(s) 200 alone without the inclusion of the bottle (s) 30b, 30c, it is an object of this invention to construct the sheet 50 so that the sheet 50 may be adhered to the chambered cap 200 in the absence of a bottle (s) 30b, 30c in such a way that the sheet 50 stays in places and prevents the first substance 74 from escaping from within the compartment 85. As shown, the advantage of the chambered cap 200 is that the first substance 74 may be neatly and completely dispensed from within the chambered cap 200.

FIG. 25 illustrates the multi-chambered container 300 showing another sealing configuration in which seal 40 is used to provide a fluid seal. The seal 40 shown and described with respect to FIGS. 8-10, is likewise provided for use in accordance with exemplary embodiment's chambered cap 200 and multi-chambered container 300.

Likewise, the multi-chambered container 300 depicted includes both, the cap container 200 in combination with the lower bottle 30b. In operation, the seal 40 is secured in place over a ridge 39 which protruding concentrically inward from the multi-chambered container 300. The sealing flange 44a of the seal 40 extends outward and compresses the sheet 50 against the upper edge 37a of the lower bottle 30b as shown in FIG. 25 (and the neck opening 37 of the regular bottle 30c in FIG. 26).

FIGS. 25, FIG. 2 and FIG. 6, for example, shows the peripheral edges 88 of the sheet 50 may include an adhesive 52 that is to be used to adhere the sheet 50 at its edges 88 to a surface 89 of the chambered cap 200.

Likewise, FIG. 24 illustrates that the peripheral edges 88 of the sheet 50 may include an adhesive 52 for securing to the surface 186a of the seal 186 or 40 (in FIG. 25) and/or any other suitable place, and in any suitable manner to an internal portion of the chambered cap 200 or seal 40. In use, the sheet 50 may be removed from a closed position (as shown in FIG. 25) in which the first substance 74 is sealed within the compartment 85, to an open position (similar to the removal of the sheet 50 as shown in FIG. 10) in which the first substance 74 is allowed to mix with a second substance 72 in compartment 87 the lower bottle 30b.

As shown in FIGS. 24-26, the chambered cap 200 can hold a predetermined measured amount of a first substance 74. It is to be understood that the chambered cap 200 may be constructed to fit a variety of different sizes and shapes available neck openings 37 for various bottles 30b and 30c whose neck openings 37 may substantially differ in size and/or shape.

Although various exemplary embodiments are shown above, it is to be understood that these examples should not be construed as limiting the scope of the invention, but as merely providing illustrations of some of the preferred embodiments of the invention. For example, the body of the bottom lower container 60 can be made of different sizes, shapes and/or configurations. Likewise, the lower container 60 may also be used for bottles other than for feeding infants, such as for providing beverages to geriatric, invalid, livestock care, sporting beverages, fruit juices, and other mixed compositions in which at least a first and a second substance are mixed to form the final composition. The final composition produced by this invention is intended to have widespread application in a variety of different industries, including, but not limited to, beverages, pharmaceuticals, chemicals, etc.

FIG. 26 demonstrates that the chambered cap 200 may be adapted for a variety of different size neck openings 37 for any number of commercially available regular bottles 30c, such as a water bottle, a sporting beverage, fruit juices and or any other bottle container in which a first substance may be mixed with a second substance in the bottle container to form the final composition.

The embodiment shown in FIGS. 24, 25 and 26 is a compact, portable mixing and/or dispensing chambered cap 200 and multi-chambered container 300 that may be used in medicinal, chemical and any other type of applications for storing, mixing and/or dispensing a composition, formed from a first and a second substance which are to remain separated before use, and mixed right before use of the composition. That is, the sheet 50 will remain in place until such time that the composition is to be used.

In another aspect of this invention, the chambered cap 200 and/or multi-chambered container 300 of this invention may be constructed so that after the first and second substance are mixed, the resulting composition is not intended to be dispensed from within the chambered cap 200 or multi-chambered container 300. For example, where a first substance and a second substance are mixed together into a final composition, a chemical reaction may take place between the first and second composition which allows them to interact and cause an illumination and/or other desired chemical result within the chambered cap 200 or multi-chambered container 300. Likewise, it is possible that the desired interaction that takes place between the first and second substances may be the release of one of the substances toward the second static substance, when combined causes a desired chemical effect, such as illumination of the content of the chambered cap 200 or multi-chambered container 300.

In this instance, the final composition is not intended to be released from within the chambered cap 200, and multi-chambered container 300. Furthermore, the containers 60, 60a, housing 80 and bottles 30, 30b, 30c may take a variety of different shapes and configurations, including being shaped and/or designed so that the containers 60, 60a, housing 80 and/or bottles 30, 30b, 30c may be disposed in multiple parts. It is further within the scope of this invention to construct the containers 60, 60a, housing 80 and/or bottles 30, 30b, 30c with multiple component parts so that more than one sheet 50 may be provided to separate more than two substances in accordance with this invention.

It will be recognized by those skilled in the art that changes or modifications may be made to the above described embodiments (100, 200, 300) without departing from the broad inventive concepts of the invention. It is understood therefore that the invention is not limited to the particular embodiment which is described herein, but is intended to cover all modifications and changes within the scope and spirit of the invention.

What is claimed:

1. A multi-chambered container for storing, mixing and dispensing a composition, comprising:
an upper chamber having a first end and a second end;
a collar fastening a nipple to the first end of the upper chamber;
a lower chamber fastening to the second end of the upper chamber;
a seal disposed between the second end of the upper chamber and the lower chamber; and
a sheet disposed in an aperture between the seal and the lower chamber, wherein the sheet separates a first substance in the upper chamber from combining with a second substance in the lower chamber, and
wherein in use, the sheet is removed from the aperture between the upper chamber and the lower chamber from a closed separating position, to an open mixing position in which the first substance and second substance are allowed to mix.

2. The multi-chambered container recited in claim 1, wherein the second end of the upper chamber further includes a retaining ridge that extends inward and is adapted to matingly secure the seal thereto.

3. The multi-chambered container recited in claim 1, wherein the lower chamber further includes a rib that extends inward,
wherein when the sheet is in a closed position, separating the first substance from the second substance, the sheet is compressed and secured in place by a peripheral edge of the seal urging the sheet up against the rib, and
wherein when the sheet is removed from the aperture, the seal butts up against the rib and fluidly seals the container from leakage.

4. The multi-chambered container recited in claim 1, wherein the sheet includes a gripping portion and an adhesive.

5. The multi-chambered container recited in claim 1, wherein the seal is integrated as part of the second end of the upper chamber as an integral unit.

6. The multi-chambered container recited in claim 1, wherein the seal is secured to the ridge on the lower chamber.

7. The multi-chambered container recited in claim 1, wherein the ridge includes a recessed portion adapted to receive and secure a portion of the seal in position.

8. The multi-chambered container recited in claim 1, wherein a construction of the seal is chosen from at least one of: a ring, a ring including a protrusion and an integrated ring.

9. The multi-chambered container recited in claim 1, wherein a plurality of seals surround a plurality of aligned perforations formed between a perforated upper chamber wall aligned with a perforated lower chamber wall.

10. A multi-chambered device for storing and mixing a composition, comprising:
an first chamber having a closed end defining a first compartment adapted to store a first substance, and an open end including a first fastening mechanism, the first chamber further includes an aperture disposed about one side of the upper chamber;
a second chamber having opening including a second fastening mechanism, and a closed end defining a second compartment adapted to store a second substance, wherein the first fastening mechanism is adapted to matingly secure to the second fastening mechanism of the lower chamber;
a seal is disposed between the first compartment in the upper chamber and second compartment in the lower chamber; and
a sheet disposed between the seal and the open end of the second chamber, the sheet is adapted to separate the first substance in the first chamber from being released, wherein in use, the sheet is removed from the multi-chambered device, from a closed position in which the first substance is sealed within the first compartment, to an open position in which the first substance is allowed to mix with the second substance in the second compartment.

11. The multi-chambered device recited in claim 10, wherein the first fastening mechanism and the second fastening mechanism are threaded fasteners.

12. The multi-chambered device recited in claim 10, wherein the closed end of the first or second chamber includes an opening through which the first substance, second substance or the mixed composition may be accessed.

13. The multi-chambered device recited in claim 10, wherein the seal is combined with the first chamber as an integral unit thereof.

14. The multi-chambered device recited in claim 10, wherein the seal is secured in place over a ridge protruding inward from the upper chamber and wherein the seal extends outward and compresses the sheet against an edge of the lower chamber.

15. The multi-chambered device recited in claim 10, wherein the sheet is adhered to an inner surface of the upper chamber.

16. The multi-chambered device recited in claim 10, wherein a peripheral edge of the sheet is adhered to the seal.

17. A chambered cap, comprising:
a housing having a first closed end and a second open end having a fastening mechanism adapted to secure the housing, the chambered cap includes an aperture disposed on the housing;
a compartment within the housing adapted to store a first substance;
a seal disposed between the compartment and the open end of the housing; and
a sheet located in the aperture, wherein in a closed position, a peripheral edge of the sheet is fastened to an inner surface of the housing thereby preventing the first substance in the housing from being released, and wherein in use, the sheet can be removed from the closed position in which the first substance is sealed within the compartment, to an open position in which the first substance is allowed to flow out of the unsealed compartment.

18. The chambered cap recited in claim 17, wherein the sheet is adhered to an inner surface of the housing.

19. The chambered cap recited in claim 17, wherein the closed end of the housing includes an opening through which the mixed composition may be accessed.

20. The multi-chambered container recited in claim 1, wherein the configuration between the rib, the retaining the ridge, the seal and the sheet, the upper chamber and the lower chamber, can be modified to be adapted in an opposed direction.
